(19) United States
(12) Patent Application Publication
(10) Pub. No.: US 2013/0052899 A1
(43) Pub. Date: Feb. 28, 2013

(54) RESIN-AND-FIBER COMPOSITE AND METHOD FOR MAKING SAME

(71) Applicants: WU LI, Shenzhen City (CN); QIANG ZHANG, Shenzhen City (CN); XUAN-ZHAN ZENG, Shenzhen City (CN); DA-QING HUANG, Shenzhen City (CN); YUAN-LEI ZHANG, Shenzhen City (CN); ZHI-WEI HU, Shenzhen City (CN); MING-LIANG WANG, Shenzhen City (CN); YUN-FENG HUANG, Shenzhen City (CN); QING XIA, Shenzhen City (CN); HE-JIE WEN, Shenzhen City (CN)

(72) Inventors: WU LI, Shenzhen City (CN); QIANG ZHANG, Shenzhen City (CN); XUAN-ZHAN ZENG, Shenzhen City (CN); DA-QING HUANG, Shenzhen City (CN); YUAN-LEI ZHANG, Shenzhen City (CN); ZHI-WEI HU, Shenzhen City (CN); MING-LIANG WANG, Shenzhen City (CN); YUN-FENG HUANG, Shenzhen City (CN); QING XIA, Shenzhen City (CN); HE-JIE WEN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/303,404

(22) Filed: Nov. 23, 2011

(30) Foreign Application Priority Data
Aug. 29, 2011 (CN) 201110251141.7

(51) Int. Cl. B32B 5/02; B32B 38/10; B29C 45/14

(52) U.S. Cl. 442/59; 264/257; 156/247

(57) ABSTRACT

A resin-and-fiber includes a base layer and a molded layer integrally bonding the base layer. The base layer includes a fiber layer made of fiber woven fabric and a resin layer made of transparent or translucent resin. The fiber layer has a first surface and an opposite second surface. The resin layer bonds the first surface and penetrating into the fiber layer. The molded layer is made of resin and integrally bonding the second surface of the fiber layer. A method for making the present resin-and-fiber composite is also provided.

### BACKGROUND

1. Technical Field

The present disclosure relates to a composite of resin and fiber and a method for making the composite.

2. Description of Related Art

Shells for portable electronic devices and household appliances are usually made of plastic. Although plastic shells can be formed at one time by injection molding, they are not very strong and are not very abrasion resistant.

In contrast, fiber (such as carbon fiber and glass fiber) is lightweight and strong, and may be more decorative over plastic. However, it is difficult to manufacture a structurally complex housing with fiber.

Therefore, there is room for improvement within the art.

### BRIEF DESCRIPTION OF THE DRAWINGS

Many aspects of the disclosure can be better understood with reference to the drawing. The components in the drawing are not necessarily drawn to scale, the emphasis instead being placed upon clearly illustrating the principles of the disclosure. Moreover, in the drawings like reference numerals designate corresponding parts throughout the views.

FIG. 1 is a schematic cross-sectional view of an exemplary embodiment of a resin-and-fiber composite.

FIGS. 2A-2D are schematic views showing different manufacturing processes in the method of manufacturing the resin-and-fiber composite according to a first embodiment.

FIGS. 3A-3C are schematic views showing different manufacturing processes in the method of manufacturing the resin-and-fiber composite according to a second embodiment.

FIGS. 4A-4C are schematic views showing different manufacturing processes in the method of manufacturing the resin-and-fiber composite according to a third embodiment.

### DETAILED DESCRIPTION

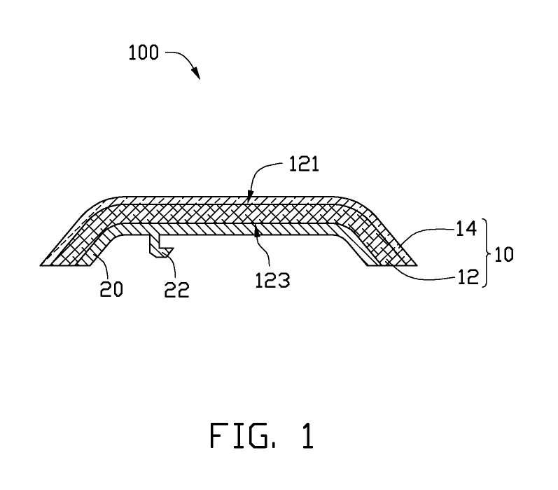

FIG. 1 shows an exemplary resin-and-fiber composite 100. In the exemplary embodiment, the resin-and-fiber composite 100 may be a battery cover of a mobile phone. The resin-and-fiber composite 100 includes a base layer 10 and a molded layer 20 bonding the base layer 10. The base layer 10 includes a fiber layer 12 and a resin layer 14 bonding the fiber layer 12. The molded layer 20 and the base layer 10 are integrally formed by injection molding.

The fiber layer 12 may be made of fiber woven fabric. The fiber woven fabric may be made of a fiber material selected one from the group consisting of carbon fiber, glass fiber, Kevler fiber, and hybrid fiber. In the exemplary embodiment, carbon fiber or glass fiber is selected. The fiber layer 12 may have a desired woven texture. The thickness of the fiber layer 12 may be about 0.2 mm-0.3 mm. The fiber layer 12 has a first surface 121 and a second surface 123 on an opposite side to the first surface 121.

The resin layer 14 bonds the first surface 121 of the fiber layer 12 and penetrates into the fiber layer 12. The resin layer 14 forms the outermost layer of the composite 100. The resin layer 14 is made of transparent or translucent resin. In the exemplary embodiment, the resin layer 14 is made of transparent epoxy resin. The resin layer 14 may enhance the rigidness of the fiber layer 12, and further more gives a smooth and glossy surface to the composite 100.

The molded layer 20 integrally bonds the second surface 123 of the fiber layer 12. The molded layer 20 may be made of resin and formed by injection molding. The thickness of the molded layer 20 may be about 0.9 mm-1.0 mm. The molded layer 20 may have assembling portions 22, such as hooks and/or clasps, configured for assembling the composite 100 to a device. Resin material for the molded layer 20 may be one or more selected from the group consisting of polyvinyl chloride (PVC) resin, polyethylene terephthalate (PET), acrylonitrile-butadiene-styrene (ABS), polycarbonate (PC), polyimide, polyetherimide (PEI), polystyrene (PS), and polypropylene (PP).

The present composite 100 may be used as housings for electronic devices (such as housings for mobile phones). The composite 100 may also be used as housings for household appliances or parts of cars.

A method for making the resin-and-fiber composite 100 include providing the base layer 10, the base layer 10 including the fiber layer 12 made of fiber woven fabric and a resin layer 14 made of transparent or translucent resin, the fiber layer 12 having the first surface 121 and an opposite second surface 123, the resin layer 14 bonding the first surface 121 and penetrating into the fiber layer 12; then inserting the base layer 10 in a cavity of a mold; and injecting a second resin into the cavity to form a molded layer 20 bonding a surface of the fiber layer 121 away from the resin layer 14.

Embodiments of the method for making the composite 100 are described as follows.

### Embodiment 1

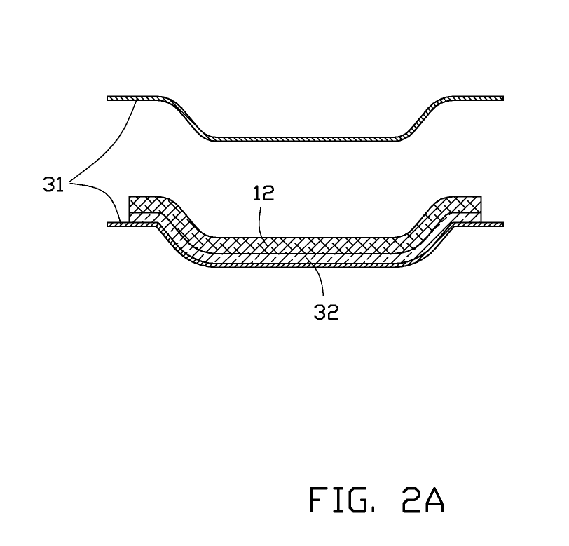

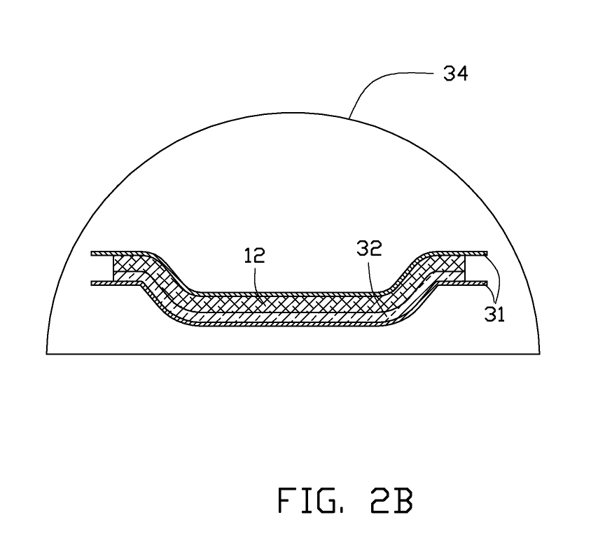

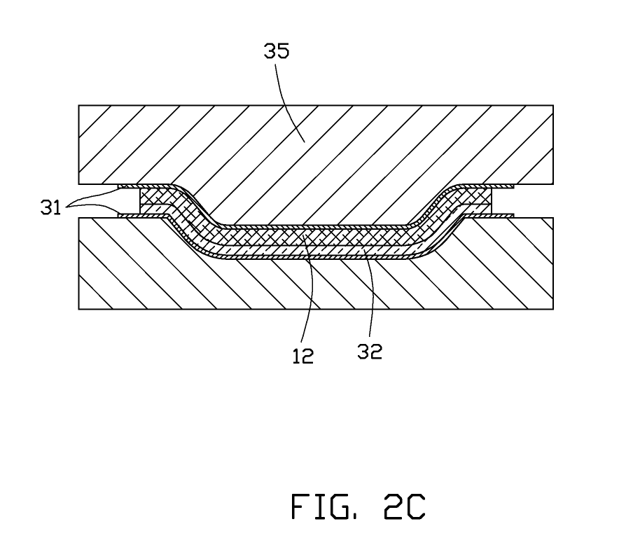

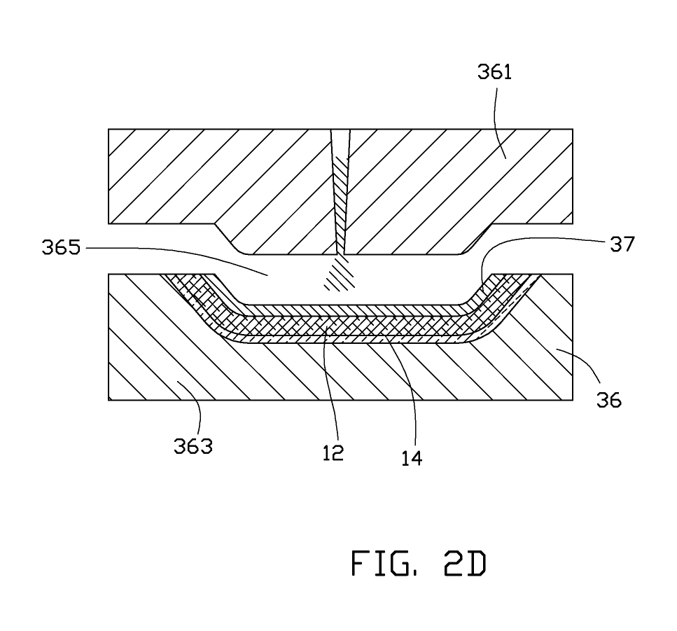

Referring to FIGS. 2A-2D, a first embodiment of the method for making the composite 100 may include the following steps.

Referring to FIG. 2A, two plastic films 31 are provided. The two plastic films 31 may be preformed to have a desired shape.

One of the plastic films 31 is coated with a first resin 32 on a surface thereof. The first resin 32 may be transparent or translucent. A fiber layer 12 is laminated onto the first resin 32 and then another plastic film 31 is laminated onto the fiber layer 12. The fiber layer 12 may be made of fiber woven fabric, such as carbon fiber woven fabric, glass fiber woven fabric, Kevler fiber woven fabric, or hybrid fiber woven fabric. In this embodiment, the first resin 32 is transparent epoxy resin.

Referring to FIG. 2B, air exists between the two plastic films 31 clamping the fiber layer 12 and the first resin 32 may be drawn by positioning the two plastic films 31 clamping the fiber layer 12 and the first resin 32 in a vacuum container 34 and vacuum-pumping the vacuum container 34. In the embodiment, the vacuum container 34 is a plastic bag.

Referring to FIG. 2C, the two films 31 with the fiber layer 12 and first resin 32 are pressed in a pressing die 35, enabling a tight bonding between the fiber layer 12 and first resin 32. During the pressing process, partial of the first resin 32 may penetrate into the fiber layer 12, and then the first resin 32 is solidified to form the resin layer 14.

The two films 31 are removed from the fiber layer 12 and the resin layer 14. The fiber layer 12 and the resin layer 14 are trimmed to be a desired shape, thereby achieving the base layer 10.

Referring to FIG. 2D, a mold 36 having a female mold 361 and a male mold 363 is provided. The male mold 363 engages with the female mold 361 to form a cavity 365.

The base layer 10 is inserted in the mold 36, and a molten second resin 37 is injected into the cavity 365 to form the molded layer 20 bonding a surface of the fiber layer 12 away from the resin layer 14, as such, the composite 100 is formed, with the resin layer 14 and molded layer 20 on opposite sides of the fiber layer 12. The second resin 37 may be selected one or more from the group consisting of PVC, PET, ABS, PC, polyimide, PEI, PS, and PP.

In the first embodiment, because dies usually have recesses or pinholes on the surfaces, thus the two films 31 are used to separate the fiber layer 12 and the resin layer 14 from the pressing die 35 during the pressing process, preventing the fiber layer 12 and the resin layer 14 from directly attaching the surface of the pressing die 35, thereby, ensuring a smooth surface for the base layer 10.

If a high surface smoothness is not desired, the two films 31 may be omitted.

The first embodiment of the method for making the composite 100 may further include a step of coating a release agent (not shown) on surfaces of the two films 31 before the step of coating the first resin 32. The release agent may help to peel the two films 31 from the fiber layer 12 and the resin layer 14 easily.

### Embodiment 2

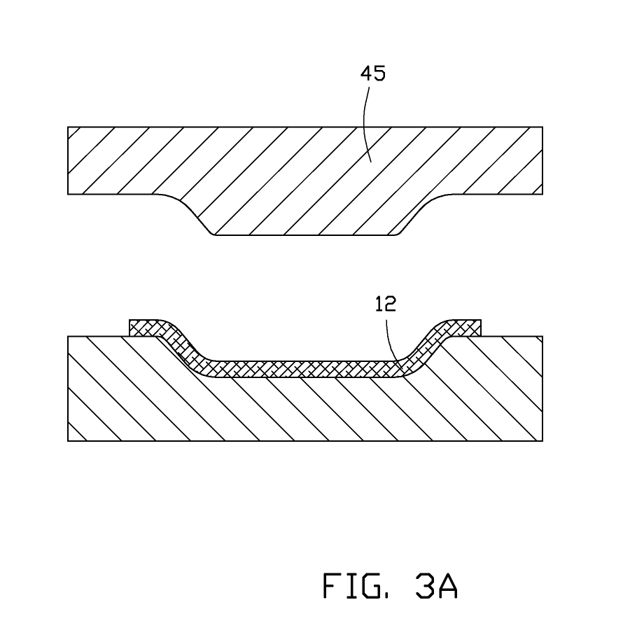

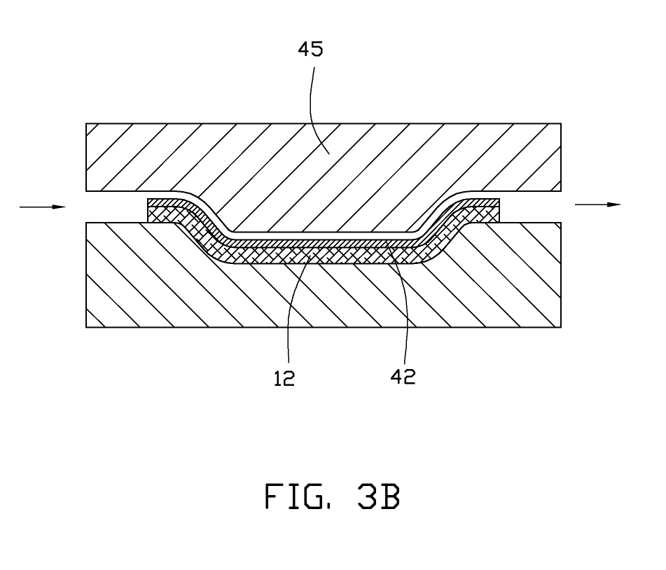

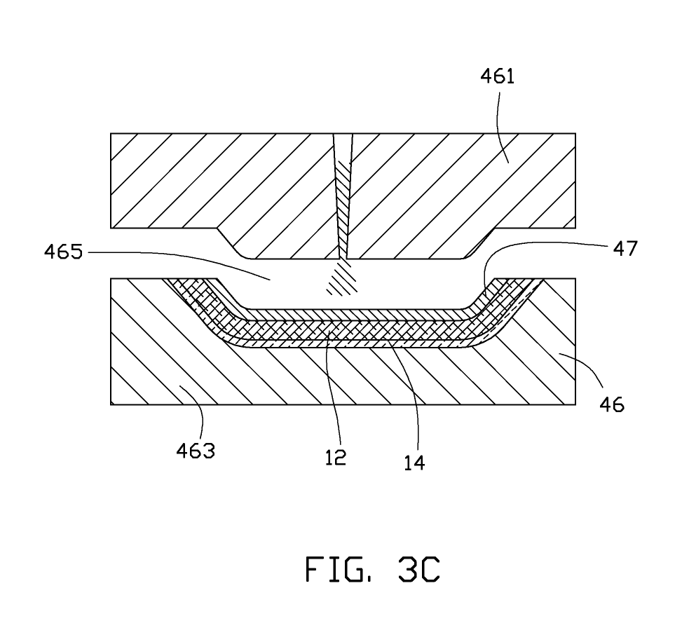

Referring to FIGS. 3A-3C, a second embodiment of the method for making the composite 100 may include the following steps.

Referring to FIG. 3A, a fiber layer 12 is laminated in a pressing die 45 which may be applied with a release agent. The fiber layer 12 may be made of fiber woven fabric, such as carbon fiber woven fabric, glass fiber woven fabric, Kevler fiber woven fabric, or hybrid fiber woven fabric.

Referring to FIG. 3B, interior of the pressing die 45 is vacuum pumped after closed. A fluid first resin 42 is fed into the pressing die 45 to coat the fiber layer 12 when vacuum pumping the pressing die 45. The first resin 42 may be transparent or translucent. By vacuum pumping, air existing between the fiber layer 12 and the first resin 42 may be removed. In this embodiment, the first resin 42 is transparent epoxy resin.

Then, the first resin 42 and the fiber layer 12 are pressed by applying a pressure onto the first resin 42 and the fiber layer 12 via the pressing die 45. During the pressing process, the first resin 42 passes through the fiber layer 12 and reaches a surface of the fiber layer 12 attaching the pressing die 45, forming the resin layer 14 when solidified.

The fiber layer 12 and the resin layer 14 are trimmed to be a desired shape, thereby achieving the base layer 10.

Referring to FIG. 3C, a mold 46 having a female mold 461 and a male mold 463 is provided. The male mold 463 engages with the female mold 461 to form a cavity 465.

The base layer 10 is inserted in the mold 46, and a molten second resin 47 is injected into the cavity 465 to form the molded layer 20 bonding a surface of the fiber layer 12 away from the resin layer 14, as such, the composite 100 is formed, with the resin layer 14 and molded layer 20 on opposite sides of the fiber layer 12. The second resin 47 may be selected one or more from the group consisting of PVC, PET, ABS, PC, polyimide, PEI, PS, and PP.

### Embodiment 3

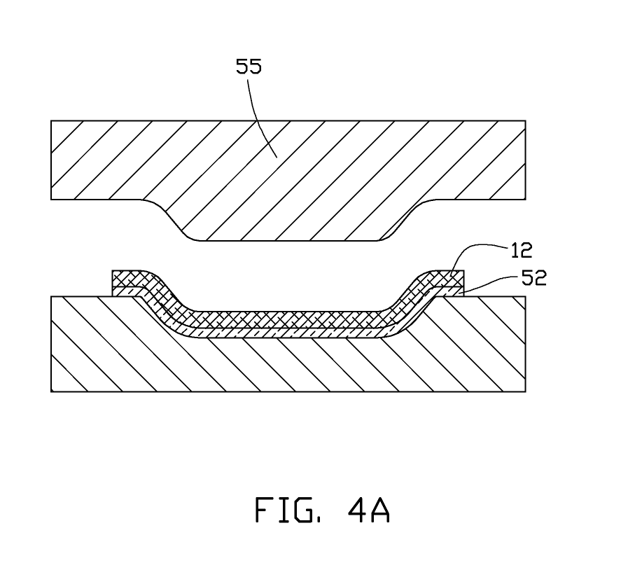

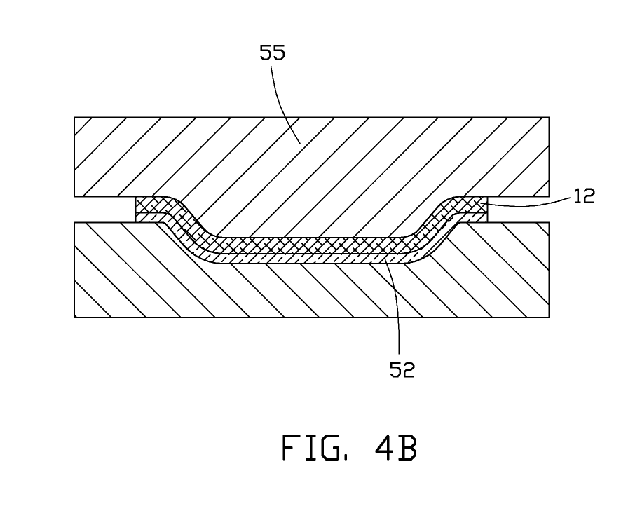

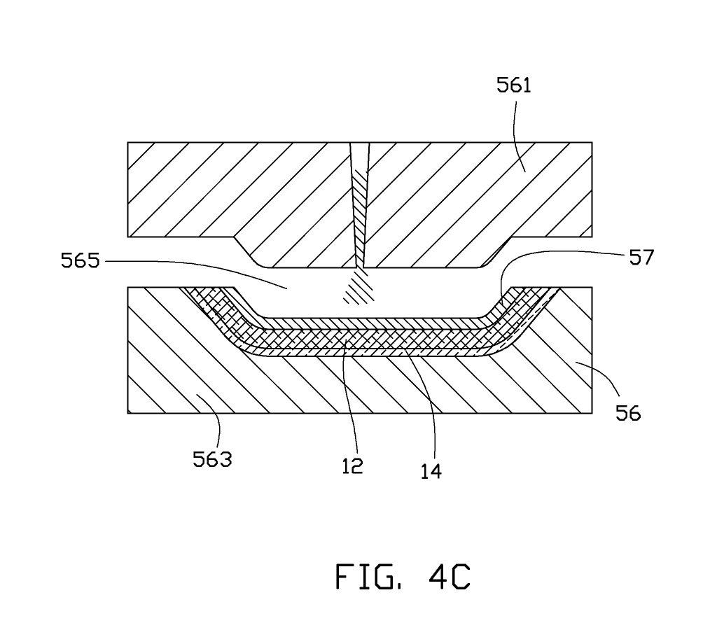

Referring to FIGS. 4A-4C, a third embodiment of the method for making the composite 100 may include the following steps.

Referring to FIG. 4A, a fiber layer 12 coated with a first resin 52 is laminated in a pressing die 55 which may be applied with a release agent, with the first resin 52 attaching the pressing die 55. The fiber layer 12 may be made of fiber woven fabric, such as carbon fiber woven fabric, glass fiber woven fabric, Kevler fiber woven fabric, or hybrid fiber woven fabric. The first resin 52 is transparent epoxy resin.

Referring to FIG. 4B, the first resin 52 and the fiber layer 12 are pressed by applying a pressure onto the first resin 52 and the fiber layer 12 via the pressing die 55. Interior of the pressing die 55 is vacuum pumped when pressing the first resin 52 and the fiber layer 12, excluding air existing between the first resin 52 and the fiber layer 12. During the pressing process, partial of the first resin 52 may penetrate into the fiber layer 12, and the first resin 52 is solidified to form the resin layer 14.

The fiber layer 12 and the resin layer 14 are trimmed to be a desired shape, thereby achieving the base layer 10.

Referring to FIG. 4C, a mold 56 having a female mold 561 and a male mold 563 is provided. The male mold 563 engages with the female mold 561 to form a cavity 565.

The base layer 10 is inserted in the mold 56, and a molten second resin 57 is injected into the cavity 565 to form the molded layer 20 bonding a surface of the fiber layer 12 away from the resin layer 14, as such, the composite 100 is formed, with the resin layer 14 and molded layer 20 on opposite sides of the fiber layer 12. The second resin 57 may be selected one or more from the group consisting of PVC, PET, ABS, PC, polyimide, PEI, PS, and PP.

The fiber layer 12 can reinforce the composite 100 and reduce the weight of composite 100. Moreover, the woven textures of the fiber layer 12 can be seen by users through the resin layer 14, creating a good three-dimensional appearance. The molded layer 20 made by injection molding has assembling portions 22, facilitating assembling the composite 100 to a device.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A resin-and-fiber composite, comprising:
a base layer, the base layer including a fiber layer made of fiber woven fabric and a resin layer made of transparent or translucent resin, the fiber layer having a first surface and an opposite second surface, the resin layer bonding the first surface and penetrating into the fiber layer; and
a molded layer made of resin, the molded layer integrally bonding the second surface of the fiber layer.

2. The composite as claimed in claim 1, wherein the resin layer is made of transparent epoxy resin.

3. The composite as claimed in claim 1, wherein the molded layer has assembling portions.

4. The composite as claimed in claim 3, wherein the assembling portions are hooks or clasps.

5. The composite as claimed in claim 1, wherein fiber woven fabric is made of a fiber material selected one from the group consisting of carbon fiber, glass fiber, Kevler fiber, and hybrid fiber.

6. The composite as claimed in claim 1, wherein the fiber layer has a thickness of about 0.2 mm to about 0.3 mm.

7. The device housing as claimed in claim 1, wherein the molded layer has a thickness of about 0.9 mm to about 1.0 mm.

8. A method for making a resin-and-fiber composite, comprising:
providing a base layer, the base layer including a fiber layer made of fiber woven fabric and a resin layer made of transparent or translucent resin, the fiber layer having a first surface and an opposite second surface, the resin layer bonding the first surface and penetrating into the fiber layer;
inserting the base layer in a cavity of a mold; and
injecting a second resin into the cavity to form a molded layer bonding a surface of the fiber layer away from the resin layer.

9. The method as claimed in claim 8, wherein the step of providing the base layer includes:
providing two plastic films, the two plastic film having a desired shape;
coating one of the plastic films with a first resin on a surface thereof and laminating a fiber layer on the first resin, and then covering another plastic film on the fiber layer, the fiber layer made of fiber woven fabric, the first resin being transparent or translucent;
drawing air existing between the two plastic films clamping the fiber layer and the first resin;
pressing the two plastic films with the fiber layer and first resin, thereby partial of the first resin penetrating into the fiber layer and the first resin solidified to form a resin layer;
removing the two plastic films from the fiber layer and the resin layer;
trimming the fiber layer and the resin layer to be a desired shape, thereby achieving the base layer.

10. The method as claimed in claim 9, wherein the step of drawing air existing between the two plastic films is carried out by positioning the two plastic films clamping the fiber layer and the first resin in a vacuum container and vacuum-pumping the vacuum container.

11. The method as claimed in claim 9, further comprising a step of coating release agent on surfaces of the two plastic films before the step of coating the first resin.

12. The method as claimed in claim 8, wherein the step of providing the base layer includes:
laminating a fiber layer in a pressing die, the fiber layer made of fiber woven fabric;
vacuum pumping interior of the pressing die, and feeding a fluid first resin into the pressing die to coat the fiber layer when vacuum pumping the pressing die, the first resin being transparent or translucent;
pressing the first resin and fiber layer via the pressing die, thereby the first resin passing through the fiber layer and reaching a surface of the fiber layer attaching the pressing die, forming a resin layer when solidified;
trimming the fiber layer and the resin layer to be a desired shape, thereby achieving the base layer.

13. The method as claimed in claim 12, wherein the pressing die is applied with release agent.

14. The method as claimed in claim 8, wherein the step of providing the base layer includes:
laminating a fiber layer coated with a first resin in a pressing die, with the first resin attaching the pressing die, the fiber layer made of fiber woven fabric, the first resin being transparent or translucent;
pressing the first resin and fiber layer via the pressing die, vacuum pumping interior of the pressing die when pressing the first resin and fiber layer, thereby partial of the first resin penetrating into the fiber layer, and the first resin solidified to form a resin layer;
trimming the fiber layer and the resin layer to be a desired shape, thereby achieving the base layer.

15. The method as claimed in claim 14, wherein the pressing die is applied with release agent.
